(19) United States
(12) Patent Application Publication
(10) Pub. No.: US 2002/0178226 A1
(43) Pub. Date: Nov. 28, 2002

(54) Method and apparatus for message escalation by digital assistants

(76) Inventors: Andrew V. Anderson, Hillsboro, OR (US); Paul R. Pierce, Portland, OR (US); Uttam Sengupta, Portland, OR (US); Ticky Thakkar, Portland, OR (US); Kit Tham, Portland, OR (US); Nick Wade, Portland, OR (US); Trevor Pering, Mountain View, CA (US); Steve Bennett, Hillsboro, OR (US); Lee Hirsch, Cupertino, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/865,919

(22) Filed: May 24, 2001

(51) Int. Cl. G06F 15/16; G06F 9/46

(52) U.S. Cl. 709/206; 709/318

(57) ABSTRACT

A method and apparatus for escalating messages to a user concerning events of importance to the user comprising receiving information concerning an event, evaluating its importance to the user, and if the event is determined to be important enough for the user to be contacted, selecting a first way of contacting the user and using that first way to do so, waiting for a period of time for the user to respond, and if the user does not respond, selecting a second way of contacting the user and using that second way to do so.

### FIELD OF THE INVENTION

The present invention is related to an apparatus and method for escalating messages to individuals by way of digital assistants, such as pagers, telephones and organizers.

### ART BACKGROUND

Electronic devices and services used to retrieve information and provide reminders of appointments are widely known.

Commonly available PDAs (“personal data assistants”) and other devices allow users to store and organize information concerning people, places and events are currently in wide use. Many such devices maintain a user's schedule and provide automated reminder functions to remind the user of an upcoming event, such as a meeting. However, these devices require that all such information be directly supplied by their users. In essence, these devices do nothing beyond what their users instruct them to do.

Commercial services to provide meeting reminders and notices of events tailored to the individual interests of subscribers are also available. Many such services provide various ways in which a subscriber can provide a list of categories of information that the subscriber wants to be informed about. However, these services require the subscriber to specify the categories or other criteria concerning the information the subscriber is interested in. In essence, these services also do nothing beyond what their users instruct them to do.

There exist commercial paging services by which a subscriber may arrange to have results of sporting events, weather reports, or notices of favorable conditions for surfing sent to a pager. Additionally, there are commercial services whereby a subscriber may arrange to receive a “wake up” call on their home telephone (or at some other telephone number) at a specified time on a given morning. However, these services are limited to contacting a subscriber by a single method prescribed by a user and for a single purpose.

Furthermore, there exists a feature in various pieces of software by which a user may be informed by email of a change made to an item under the user's control in a database or in a piece of programming code for which the user is responsible. However, this entails the use of a very limited option for contacting a user for very limited reasons.

### BRIEF DESCRIPTION OF THE DRAWINGS

The objects, features, and advantages of the present invention will be apparent to one skilled in the art in view of the following detailed description in which:

FIG. 1 is a block diagram of one embodiment of the present invention.

FIG. 2 is a flow chart followed by one embodiment of the present invention.

### DETAILED DESCRIPTION

In the following description, for purposes of explanation, numerous details are set forth in order to provide a thorough understanding of the present invention. However, it will be apparent to one skilled in the art that these specific details are not required in order to practice the present invention.

The present invention concerns the escalating of selected information to the user of an automated assistant. Such escalation of selected information to a user could be done through portable or hand-held devices such as pagers, PDAs, mobile telephones or portable computers to keep the user up to date concerning his personal schedule. However, as those skilled in the art will appreciate, the present invention is also applicable to the use of non-portable devices such as stationary computer systems or landline telephones, and may be used to provide information concerning issues other than personal schedule, such as current events, or affairs involving other people with some importance or connection to a user.

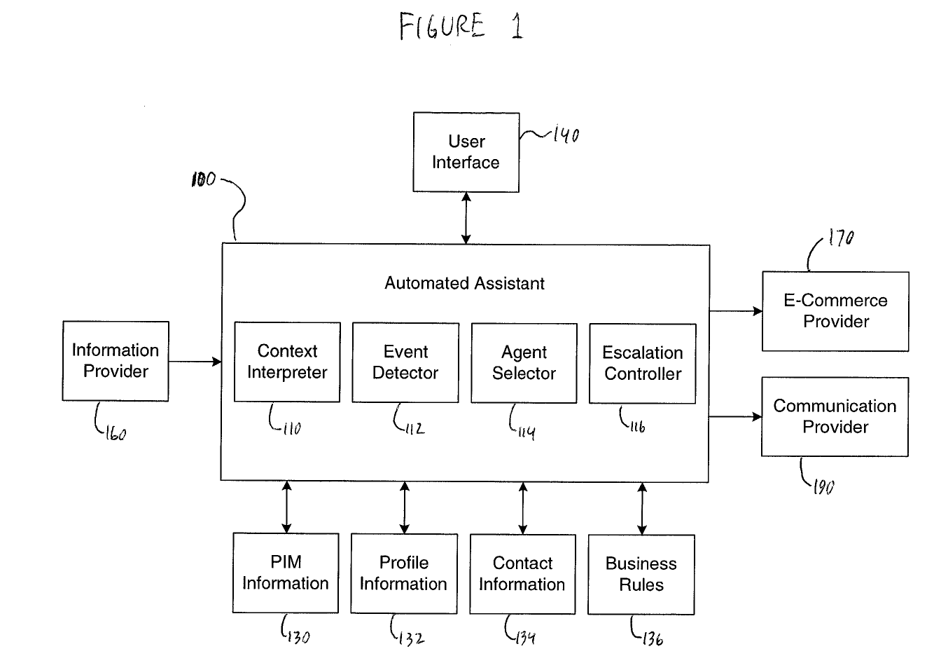

FIG. 1 is a block diagram of one embodiment of the present invention. Automated assistant 100 is comprised of context interpreter 110, event detector 112, agent selector 114 and escalation controller 116. Automated assistant 100 relies on various pieces of information concerning a user including, but not limited to, PIM information 130, profile information 132, contact information 134 and rules 136. User interface 140 allows a user to customize automated assistant 100. Automated assistant 100 receives information that may be of importance to a user from at least one information provider 160, and automated assistant 100 may interact with at least one e-commerce provider 170 in order to carry out instructions from a user. At least one communication provider 190 is used by automated assistant 100 to provide remote communication with a user. In one embodiment, such communication may include access to user interface 140.

In one embodiment, user interface 140 is an application run by a user on a computer system used to gain access to automated assistant 100. In this embodiment, user interface 140 may be presented by way of web pages viewable using commonly available web browsers. In another embodiment, user interface 140 is accessible only to a service provider that provides the services of automated assistant 100 to a user. In this embodiment, a user's interaction with automated assistant 100 may be limited to the remote communication provided through communication provider 190.

PIM information 130 is maintained by automated assistant 100 and is comprised of daily information concerning a user. In one embodiment, this information includes, but is not limited to, the kinds of information often maintained on currently available PDA devices, such as a calendar of scheduled events and appointments, an address list, a phone list and memos by the user such as a “to-do” list. In one embodiment, this information is updated on a recurring basis from a PDA device carried by a user. In another embodiment, this information is provided by the user through use of user interface 140. In yet another embodiment, the user provides this information to automated assistant 100, directly through such devices as a pager or mobile phone. In still another embodiment, PIM information 130 additionally includes information concerning another person to whom a user may have delegated the authority to respond to one more types of events. For example, PIM information 130 may contain some information concerning the schedule of that other person for use in determining whether or not that other person is available in lieu of the user at a given time.

Profile information 132 is maintained by automated assistant 100 and is comprised of information concerning a user's preferences. Such information could include, but is not limited to, e-commerce providers that a user prefers to use for particular products or services, whether the user prefers a window or aisle seat on an airplane, a user's tastes in food, a user's membership in frequent flier mileage programs or business rate rental car programs, whether a user prefers to make all travel arrangements or is willing allow that to be done by others, a user's preference for primary means of communication, a user's preferred commute routes, as well as which stocks or travel locations are of greatest interest to a user. Such information might also include, preferences about circumstances or types of events where a user prefers that another person be contacted in lieu of the user, such as a secretary, friend or family member of the user. In one embodiment, a user would provide such information to automated assistant 100, directly, possibly via user interface 140. In another embodiment, automated assistant 100 would derive such information by observing a user's behavior over time. In still another embodiment, a user would directly supply such information, but over time, automated assistant 100 would record the degree to which the user did or did not adhere to that supplied information.

Contact information 134 is maintained by automated assistant 100 and is comprised of information concerning what means are available to contact a user. In one embodiment, such information would comprise phone numbers for a user's pager, mobile phone, home telephone and/or business telephone, along with data concerning whether text messages can be received on a user's pager or mobile phone. In another embodiment, such information would comprise email addresses by which a user could be contacted. In yet another embodiment, such information would comprise phone numbers of places outside of work or home where a user could be found. In still other embodiments, contact information 134 may further comprise contact information on other individuals to which a user has given authority to handle one or more events in lieu of the user, such as secretaries, friends or family members of the user.

Rules 136 is maintained by automated assistant 100 and is comprised of a set of rules that must be followed in carrying out various functions. In one embodiment, such information would be supplied by the user and would comprise limits on how much money may be spent on carrying out certain functions without first obtaining the user's approval, steps that must be followed in making reservations for travel or lodging, limits on the manner in which certain devices may be used in efforts to reach the user, limits concerning times during the day when the user does not want to be bothered, circumstances in which not the user, but another person to whom the user may have given authority to deal with one or more certain events, as well as exceptions to one or more of such rules.

Context interpreter 110 tracks the activities and/or whereabouts of a user. In one embodiment, context interpreter uses the calendar being maintained as part of PIM information 130 to track the user, relying on the assumption that the user will generally follow what is scheduled on that calendar.

Event detector 112 receives both information from information provider 160 and input from context interpreter 110 as to what a user is currently doing and will be doing in the future, and uses that information, along with profile information 132 and/or rules 136, to make a determination as to what action, if any, should be taken in response. Event detector 112 examines the information received from information provider 160 to see if there are any indications of anything that might effect the activities that a user is currently engaged in, or will be engaged in, such as attending a meeting or making investments. Event detector 112 also examines the information received to determine if there is something that has happened or will be happening that may cause the user to want to add an activity, such as attending a convention concerning a subject of interest to the user.

In one embodiment, the information received from information provider 160 would comprise weather updates, traffic reports, and news of such events as sales or special local events that may be of interest to a user engaged in local activities. In another embodiment, the information received would comprise flight arrival and departure schedules, weather conditions at distant locations and along routes of travel, and the occurrence of major events at distant locations that may be of interest or have an impact on the travel plans of a traveling user. In still another embodiment, the information received would comprise stock quotes, earnings reports by corporations, and announcements by government agencies or other institutions of interest to a user engaged in making investments.

If event detector 112 determines that an event has occurred that requires an action to be taken, then agent selector 114 receives indications from event detector 112 that an event of interest to a user has occurred, along with an indication from event detector 112 of the degree to which the event is of importance to the user. Taking into account the nature of the event and the degree of interest to the user, agent selector 114 determines whether the user should be contacted, whether another person that the user has given authority to handle certain events on the user's behalf should be contacted, or whether automated assistant 100 could independently take action that would be sufficient without disturbing the user. If it is determined that the user must be contacted, then agent selector uses contact information 134 to select the means by which the user must be informed. In selecting a means by which the user must be informed, agent selector 114 may take into account the different limits imposed by the different means by which the user may be informed. For example, the user may have a pager that may or may not be able to display text information to the user, and if the pager has text capability, then there may be limits on the number of characters that can be sent. Such limits on the pager may make it more desirable to contact the user by way of an available text-enabled cell phone, if the message that must be communicated is lengthy, and the text-enabled cell phone is able to accept and/or display a larger message.

By way of example, if in one embodiment, a user was invited to attend a meeting, but opted not to do so, then there is no need for the user to be contacted if the meeting is later cancelled, because this event is of no importance to the user, and so agent selector 114 may simply send an acknowledgement to the sender of a note that the meeting was cancelled. However, if the user had chosen to attend the meeting, and it is later cancelled, then agent selector 114 would refer to contact information 134 to select a means of reaching the user to inform the user of the cancellation. If the meeting was scheduled to occur in the very near future, and so the cancellation is very much at the last minute, then agent selector 114 might use a means of reaching the user that would be more appropriate for providing the user with a swift notification of the cancellation, such as the user's pager or mobile phone. However, if the cancelled meeting was to occur quite some time later, then agent selector 114 may choose to send the user an email which the user can receive and read at leisure, or agent selector may choose to contact a person that the user has specified as someone to deal with such a situation on the user's behalf, such as a secretary, since this information is not so urgent.

In another embodiment, where agent selector 114 is selecting a means by which to contact a user, agent selector 114 refers to rules 136, as well as contact information 134, in making that selection. Although the user may need to be urgently contacted concerning an event, rules 136 may indicate that it is currently night time, and the user has specified that contact is to take place at night only under specific circumstances, and so agent selector 114 may wait until morning if the event does not fit those specific circumstances. In essence, agent selector 114 weighs the importance of contacting the user against the intrusion to the user of doing so, and chooses the appropriate time and means of contacting the user.

In still another embodiment the agent selector 114 contains a small number of templates in which events of a given type or severity are mapped to a specific defined action to be taken. Part of that defined action may be to contact one or more specific persons or contacts other than the user. Such specific persons might be emergency personnel or a user's secretary or administrative assistant. For example, in one embodiment, a template might specify that flight cancellations are to be handled only by the user—no other person, and not automated assistant 100. Or, in another example, a template might specify that flight cancellations will be assigned to an administrative assistant if more than a specified amount of time exists before the scheduled departure time.

If it was determined that an event required that a user be contacted, and contact was attempted by agent selector 114, but has been unsuccessful in reaching the user, then escalation controller 116 determines when and how to escalate the effort to contact the user. In one embodiment, escalation controller 116 monitors the initial effort made by agent selector 114 to contact the user via an initial choice of device, and if the attempt is unsuccessful after a certain period of time, escalation controller 116 prods agent selector 114 to try harder by making another attempt, and perhaps by using a different device. In another embodiment, escalation controller 116 may be combined with agent selector 114, and the combined agent selector and escalation controller may simply reevaluate the initial weighing of the importance of contracting the user against the intrusion of doing so, now that more time has passed, and the need to contact the user may have become more urgent.

By way of example, the user may have been scheduled to take a flight later in the day, but the flight has now been cancelled, and the user needs to be informed. From information found in the calendar maintained as part of PIM information 130, it may be determined that user is currently in a meeting, and from information found in rules 136, the user does not like to be disturbed during such a meeting. However, because the cancelled flight was to depart later that same day, perhaps even shortly after the meeting the user is currently attending, there is a need to contact the user during the meeting, in spite of the intrusiveness of doing so. In response, agent selector 114 refers to contact information 134, discovers that the user has a pager capable of receiving text messages, and sends the user a text message on the user's pager. However, for whatever reason, a reasonable period of time passes without the user having contacted automated assistant 100 to schedule a new flight or to abandon making the trip, altogether, and so escalation controller 116 prods agent selector 114 into trying harder. Agent selector 114 again reviews contact information 134 and rules 136 and determines that making an effort to reach the user by way of a speech-synthesized voice to the user's mobile phone is now appropriate, and does so. However, for whatever reason, the user does not answer, and so now agent selector 114 refers to PIM information 130 to obtain the telephone number of the conference room in which the user is scheduled to have a meeting (if that information is there), and places a call to that conference room. Many other scenarios are possible, and as those skilled in the art will understand, the above is but one example of how an event might be handled by an embodiment of the present invention.

User interface 140 provides a user with a way to supply information needed to prepare automated assistant 100 for normal operation. In one embodiment, automated assistant 100 is maintained on centralized computer systems by a commercial provider of automated assistant 100 as a service to users to subscribe to, and an embodiment of user interface 140 could be a web page accessible to a user via the internet. In another embodiment, automated assistant 100 is maintained on a computer system owned by a user (or otherwise more locally accessible to a user), and user interface 140 could be an application that a user would run on that computer system.

Communication provider 190 is one or more of the providers of the services used by automated assistant 100 in its attempts to contact the user, and may be comprised of mobile phone service providers, paging service providers, internet service providers, etc. As discussed, earlier, in one embodiment, information concerning phone numbers or email addresses by which a user may be reached are maintained as part of contact information 134. Contact information 134 may also contain information about service charges and billing rates for each service provider 190, and such information may be among the factors weighed by either agent selector 114 or escalation controller 116 in determining when or how to contact a user. For instance, a user may have a satellite telephone by which the user could be reached in areas or at times when more conventional paging or mobile phone services are unavailable, but the need to reach the user in a particular instance may not be so pressing as to warrant incurring the high costs that might be associated with using such a recently developed means of contacting the user.

E-commerce provider 170 may be the provider of such services as online shopping (i.e., shopping for goods or services over the internet or other electronic means), remote booking of travel services, calling in of food orders, etc. For example, if e-commerce provider 170 provides the ability to make or change flight reservations, then in the above example concerning a cancelled flight, automated assistant 100 could have simply made new flight arrangements on behalf of the user, perhaps also altering reservations for rental transportation and/or hotel accommodations. In one embodiment, whether or not automated assistant 100 would engage in making such arrangements on behalf of a user would depend on whether or not information within rules 136 indicates that the user is willing to allow automated assistant 100 to do so. It may be that the user wishes to make all arrangements and only wants automated assistant 100 to provide a warning of the need to do so. Alternatively, the user may be willing to let automated assistant 100 make such arrangements and then inform the user of the changes already made, but with a limitation on the highest price that the user is willing to allow automated assistant 100 to agree to on behalf of the user.

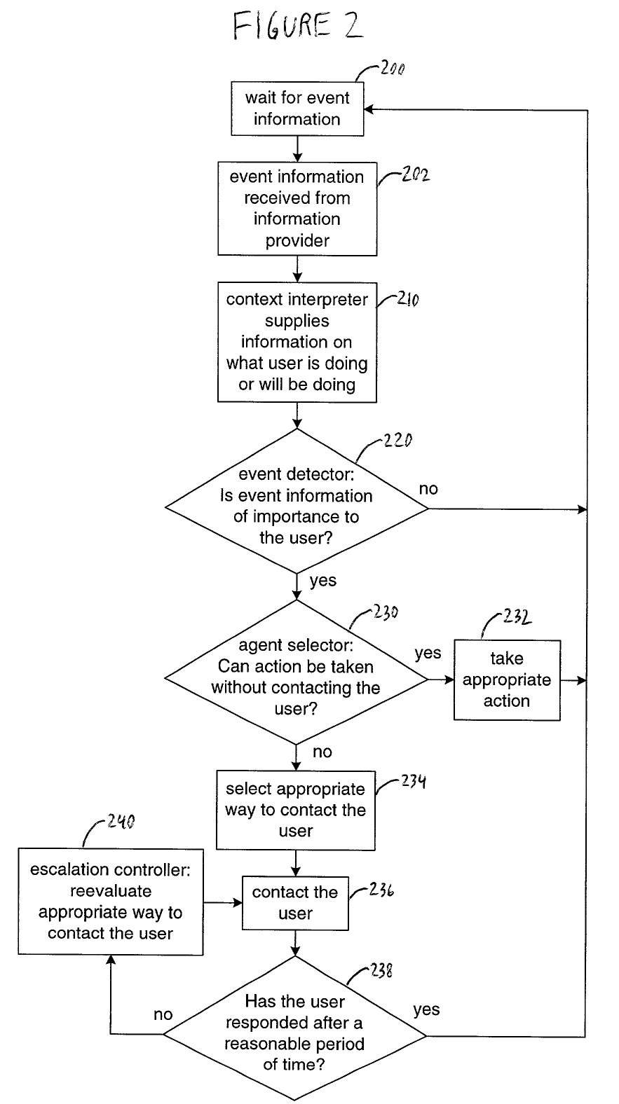

FIG. 2 is a flow chart followed by one embodiment of the present invention. A user's automated assistant waits for information concerning an event at 200. After event information is received at 202, the context interpreter of the automated assistant supplies information concerning what the user is doing now or what the user will be doing at 210. In one embodiment, the context interpreter retrieves this information from the user's calendar of scheduled events. In an alternate embodiment, the context interpreter retrieves this information from other sources that are able to supply an indication of what the user is currently doing or where the user is currently located.

At 220, the event detector of the automated assistant determines whether or not the event information is of importance to the user based on what the user is doing now or what the user will be doing, as well as based on what the user's interests are known to be from the user's profile information. If the event information is not of importance to the user, then the automated assistant takes no further action, and returns to waiting for event information at 200.

However, if the event information is of importance to the user, then the agent selector of the automated assistant determines whether or not the automated assistant can take appropriate action on its own, without having to contact the user. It might be appropriate for the automated assistant to act on its own, if the event concerns renewing a subscription or making an alteration in a reservation that the user would not have wanted to be bothered with. In one embodiment, the agent selector of the automated assistant would refer to the user's profile information to determine the user's preferences for whether or not the user would prefer to be involved in handling the event. In an alternate embodiment, the agent selector would refer to the rules information supplied by the user to see if there is a constraint on price amounts or a specific set of circumstances under which the user has specified that the user or another person acting on the user's behalf must be contacted which the event might meet. If the agent selector of the automated assistant determines that the event is one that the automated assistant can respond to without contacting the user, then the agent selector undertakes such action at 232.

However, if the agent selector of the automated assistant determines that the user must be contacted, then the agent selector refers to the user's contact information to determine the appropriate means for contacting the user. In one embodiment, the agent selector would also refer to the user's preferences for any indications of a preferred way in which the user would want to be contacted. In an alternate embodiment, the agent selector would also refer to the user's rules to determine if there are any requirements or limits supplied by the user concerning when or how the user may be contacted. For example, the user may have indicated a preference that the automated assistant contact the user on the user's text-enabled cell phone, but the user may have also supplied a rule that the user does not want to be called on his cell phone after a certain hour of the night, and that the user's text-enabled pager is always to be used after that hour. After selecting an appropriate way to contact the user at 234, the agent selector carries out contacting the user at 236.

If, at 238, the user has not responded, then at 240, the escalation controller of the automated assistant reevaluates the appropriate way to contact the user, taking into account any effect that the passage of time may have on how urgently the user needs to be contacted. It may be the case that the event is not something that needs to be responded to very urgently, and so the choice may be to try to contact the user, again, by the same means that were used to try and contact the user, originally. However, it may also be the case that the event is something that has become more urgent as a result of the passage of time, such as a change to a fast approaching, scheduled event in the user's calendar, and so the escalation controller may choose to use another means of contacting the user, one that may not have been what the user would have preferred, but which may now be necessary. In making this reevaluation, the escalation controller, like the agent selector, may refer variously to the user's preferences and/or the rules supplied by the user. At 236, another attempt would be made to contact the user, and again, the automated assistant would wait at 238 for an appropriate time for the user to respond before making further attempts.

However, if at 238, the user has responded to the initial attempt to contact the user, then the automated assistant returns to waiting for new event information at 200.

The invention has been described in conjunction with the preferred embodiment. It is evident that numerous alternatives, modifications, variations and uses will be apparent to those skilled in the art in light of the foregoing description.

The example embodiments of the present invention are described in the context of an automated assistant with its components organized in a specific configuration, and intended to run on a computer system in support of a single user. However, as those skilled in the art will appreciate, the present invention may be practiced with the various pieces of information on a given user being organized differently than has been described in detail, herein. Specifically, a user's preferences may be combined with the rules, and/or a user's contact information may be combined with a user's PIM information, and so on. Also, a single automated assistant or instance of a piece of automated assistant software may be used to provide automated assistant services to a plurality of users. This plurality of users may be members of a family, employees of a business, or may be individuals with no other connection with each other beyond making use of the same commercial provider of such services. Furthermore, users may also be individuals to whom a user has delegated responsibility for handling particular events, such as a secretary or administrative assistant, or others who use an automated assistant on behalf of another user. Furthermore, the present invention may be practiced using a dedicated automated assistant device that comprises dedicated hardware, as opposed to being practice as automated assistant software designed to be run on any of a number of commonly available computer systems.

What is claimed is:

1. A method, comprising:
receiving information of an event;
determining whether or not the event is of enough importance to the user to contact a first person concerning the event; and
if the event is of enough importance to the user, then selecting a first person to contact, selecting a first way to contact the first person, attempting to contact the first person using the first way, and waiting for a period of time for the first person to respond.

2. The method of claim 1, further comprising:
selecting a second way to contact the first person and attempting to contact the first person if the event is of enough importance to the user, the first person has not responded within the period of time, and there is a second way to contact the first person that is acceptable; and
selecting a second person to contact and a way to contact the second person if the event is of enough importance to the user, the first person has not responded within the period of time, there is not a second way to contact the first person that is acceptable, and there is a way to contact the second person that is acceptable.

3. The method of claim 1, wherein determining whether or not the event is of enough importance to the user comprises comparing the subject of the event to a list of subjects of interest to the user.

4. The method of claim 1, wherein determining whether or not the event is of enough importance to the user comprises comparing the timing of the event to activities in which the user is engaged or will be engaged listed in a calendar.

5. The method of claim 1, wherein determining whether or not the event is of enough importance to the user comprises referring to information concerning the user's preferences to determine if the user would prefer that action be taken on behalf of the user to respond to the event without contacting any person.

6. The method of claim 1, wherein determining whether or not the event is of enough importance to the user comprises referring to information concerning rules specified by the user concerning circumstances in which the user will not permit action to be taken without the first person being contacted.

7. The method of claim 2, wherein selecting the first person and the second person comprises referring to information concerning the user's preferences concerning which persons are to be contacted for particular events.

8. The method of claim 2, wherein selecting the first way to contact the first person and determining whether or not there is a second way to contact the first person that is acceptable comprises referring to information concerning the first person's preferences for when and how the first person would prefer to be contacted.

9. The method of claim 2, wherein selecting the first way to contact the first person and determining whether or not there is a second way to contact the first person that is acceptable comprises referring to information concerning the limitations of each of the available ways to contact the first person.

10. The method of claim 2, wherein selecting the first way to contact the first person and determining whether or not there is a second way to contact the first person that is acceptable comprises referring to rules specified by the first person concerning circumstances under which the first person requires that no attempt be made to contact the first person.

11. The method of claim 10, wherein referring to rules specified by the first person further comprises referring to information exceptions to those rules.

12. The method of claim 1, wherein the first person is selected from the group consisting of the user, a family member of the user, a friend of the user, an employee of the user, and a coworker of the user.

13. The method of claim 1, wherein the first way to contact the first person is selected from the group consisting of a landline telephone, a mobile telephone, a text-enabled mobile phone, a pager, a text-enabled pager, a computer system capable of conveying text messages, a computer system capable of conveying audio messages, and a computer system capable of conveying video messages.

14. A computer readable medium comprising instructions, which when executed by a processor, causes the processor to:
receive information of an event;
determine whether or not the event is important enough to the user to contact a first person concerning the event; and
select a first person to contact, select a first way to contact the first person, attempt to contact the first person using the first way, and wait for a period of time for the first person to respond, if the event is of enough importance to the user.

15. The computer readable medium of claim 14, wherein the processor is further caused to:
select a second way to contact the first person and attempt to contact the first person using the second way if the event is important enough to the user, and the first person has not responded within the period of time, and there is a second way that is acceptable; and
select a second person to contact and a way to contact the second person if the event is important enough to the user, the first person has not responded within the period of time, there is not a second way that is acceptable, and there is a way to contact the second person that is acceptable.

16. The computer readable medium of claim 14, wherein the processor is caused to determine if the event is important enough to the user by comparing the subject of the event to a list of subjects of interest to the user.

17. The computer readable medium of claim 14, wherein the processor is caused to determine if the event is important enough to the user by comparing the timing of the event to activities in which the user is engaged or will be engaged listed in a calendar.

18. The computer readable medium of claim 14, wherein the processor is caused to determine whether or not the event is important enough to the user by referring to information concerning the user's preferences to determine if the user would prefer that action be taken on behalf of the user to respond to the event without contacting any person.

19. The computer readable medium of claim 14, wherein the processor is caused to determine whether or not the event is important enough to the user by referring to information concerning rules specified by the user concerning circumstances in which the user will not permit action to be taken without the first person being contacted.

20. The computer readable medium of claim 15, wherein the processor is caused to select the first person and the second person by referring to information concerning the user's preferences concerning which persons are to be contacted for particular events.

21. The computer readable medium of claim 15, wherein the processor is caused to select the first way to contact the first person and to determine whether or not there is a second way to contact the first person that is acceptable by referring to information concerning the first person's preferences for when and how the first person would prefer to be contacted.

22. The computer readable medium of claim 15, wherein the processor is caused to select the first way to contact the first person and to determine whether or not there is a second way to contact the first person that is acceptable by referring to information concerning the limitations of each of the available ways to contact the first person.

23. The computer readable medium of claim 15, wherein the processor is caused to select the first way to contact the first person and to determine whether or not there is a second way to contact the first person that is acceptable by referring to rules specified by the first person concerning circumstances under which the first person requires that no attempt be made to contact the first person.

24. The computer readable medium of claim 14, wherein the first person is selected from the group consisting of the user, a family member of the user, a friend of the user, an employee of the user, and a coworker of the user.

25. The computer readable medium of claim 14, wherein the first way to contact the first person is selected from the group consisting of a landline telephone, a mobile telephone, a text-enabled mobile phone, a pager, a text-enabled pager, a computer system capable of conveying text messages, a computer system capable of conveying audio messages, and a computer system capable of conveying video messages.

26. A method, comprising:
receiving information concerning at least one activity in a users schedule, at least one subject of interest to the user, a first way to contact a first person selected by the user, at least one preference of the first person for how the first person is to be contacted, and at least one requirement of the first person restricting when the first person may be contacted;
receiving information concerning an event;
referring to the information concerning the at least one activity and the at least one subject of interest to determine if the event is of importance enough to the user to contact the first person; and
referring to the information concerning the first way to contact the first person, the at least one preference and the at least one requirement to determine how to contact the first person.

27. The method of claim 26, wherein the first person is selected from the group consisting of the user, a family member of the user, a friend of the user, an employee of the user, and a coworker of the user.

28. The method of claim 26, wherein the information concerning the first way to contact the first person comprises information concerning limitations of a device used in the at least one way to contact the first person.

29. The method of claim 26, wherein the first way to contact the first person is selected from the group consisting of a landline telephone, a mobile telephone, a text-enabled mobile phone, a pager, a text-enabled pager, a computer system capable of conveying text messages, a computer system capable of conveying audio messages, and a computer system capable of conveying video messages.

30. The method of claim 26, wherein the information concerning the at least one preference comprises a preference in favor of the first way to contact the first person over a second way to contact the first person.
